(19) United States
(12) Patent Application Publication
(10) Pub. No.: US 2004/0006850 A1
(43) Pub. Date: Jan. 15, 2004

(54) Personal pen retaining system

(76) Inventor: David B. Wax, New York, NY (US)

Correspondence Address: David Wax, P. O. Box 453, New York, NY, 10024, US

(21) Appl. No.: 10/613,951

(22) Filed: Jul. 5, 2003

Related U.S. Application Data
(60) Provisional application No. 60/394,298, filed on Jul. 9, 2002.

(51) Int. Cl. B43K 25/00

(52) U.S. Cl. 24/10 R

(57) ABSTRACT

A system of securing a pen to one's person so as to prevent accidental loss or theft. The system tethers a pen to an individual's clothing or clothing-accessory by a retractile cord while still allowing both normal use of the secured pen as well as convenient storage of the pen when not in use. The retaining system provides for securing a wide variety of pens or other similarly-shaped/sized implements to which a person may wish to apply it. The system is compact, lightweight, and without excessive tension so as not to hinder the normal use of the implement or appear unsightly when worn with a variety of clothing.

This application claims the benefit of previously filed provisional patent application No. 60/394,298 filed Jul. 9, 2002.

### BACKGROUND OF THE INVENTION

The common experience of not having a pen when one is needed is a cause of annoyance, delay, and reduced efficiency/productivity. Losing pens is especially common in those who work away from their own desk or frequently change locations (e.g. doctors/nurses, delivery persons, salespersons, clerks, officers, builders/engineers, consultants, etc . . . ) Loss may also occur when the pen is borrowed by another person who then fails to return it.

The desire to secure a writing implement to its place of use was evident in prior art as far back as 1922 in U.S. Pat. No. 1,462,108 which shows a pencil chained to a receptacle for said pencil which includes a clamp for securing said receptacle to a telephone. In 1924 U.S. Pat. No. 1,511,167 teaches of a similar system with a base that can be secured to a flat surface, as well as a flexible tether attached to a metal pencil clip allowing increased range of motion. Many subsequent patents (as recently as 2001 in U.S. Pat. No. 6,167,596) have improved upon these ideas making the system more secure, attractive, and serviceable, and they are now commonly seen in banks, post offices, and other public places where pens are needed and shared but are at risk of theft.

Similarly, recent prior art demonstrates an interest in methods of carrying a pen on one's person. A 1998 U.S. Pat. No. 5,718,023 shows a belt clip/holster for a pen, and 2002 U.S. Pat. No. 6,394,677 shows a pen which includes a cord allowing it to be worn around the neck.

Neither of these approaches provides a completely satisfactory method for the purposes of securing one's personal pen. The aforementioned pen-anchoring designs typically incorporate special pens which use a refillable ink, or the pen and anchor may instead form a single, disposable unit. This forces consumers to use a pen of the manufacturer's choice/design and requires replacement of the ink or the entire unit when the ink is depleted. This is inconvenient, costly, and unsatisfactory in an age when there is such a wide variety of pen designs readily available-both disposable and refillable, inexpensive and expensive. This variety allows each person to choose their favorite pen design in terms of comfort, performance, appearance, availability, and cost. The former designs are also more appropriate for permanent fixation to an immobile surface, not an ambulatory individual. The aforementioned wearable designs allow the pen to be worn and carried on one's own person making them person-dependent rather than location-dependent, but they provide no security for the pen once it is removed for writing, thus making loss a possibility with each use.

### BRIEF SUMMARY OF THE INVENTION

The object of the present invention is to provide a system of securing a pen to one's person so as to prevent accidental loss or theft of the pen. The system tethers a pen to an individual's person with a retractile cord while still allowing both normal use of the secured pen and storage when carried but not in use. It also permits use by another person, but only in close proximity to the pen's owner. The system design also provides for securing a wide variety of pens or other similarly shaped/sized implements (e.g. pencil, touch-tablet stylus, laser pointer, etc . . . ) to which a person may wish to apply it. The design is also intended to be compact, lightweight, and without significant tension so as not to hinder the normal use of the implement or appear unsightly when worn with a variety of clothing.

### BRIEF DESCRIPTION OF THE SEVERAL VIEWS OF THE DRAWING

In the accompanying drawings:

FIG. 1 is a perspective view of an embodiment of the pen retaining system with the pen-connector uncoupled from the pen-holder as during use;

FIG. 2 is a perspective view of the present invention as shown in FIG. 1 but with a pen (in dashed lines) coupled with the pen-connector, and with the pen-connector coupled with the pen-holder for pen storage;

FIGS. 3A-C are three orthogonal views of the embodiment shown in FIG. 1;

FIG. 4 is a single view of an alternative embodiment of the present invention;

FIGS. 5A-C are three orthogonal views of an alternative embodiment of the present invention;

FIGS. 6A-C are three orthogonal views of an alternative embodiment of the present invention;

FIGS. 7A-C are three orthogonal partial views of an alternative embodiment of the present invention;

FIGS. 8A-B are two orthogonal partial views of an alternative embodiment of the present invention.

### DETAILED DESCRIPTION OF THE INVENTION

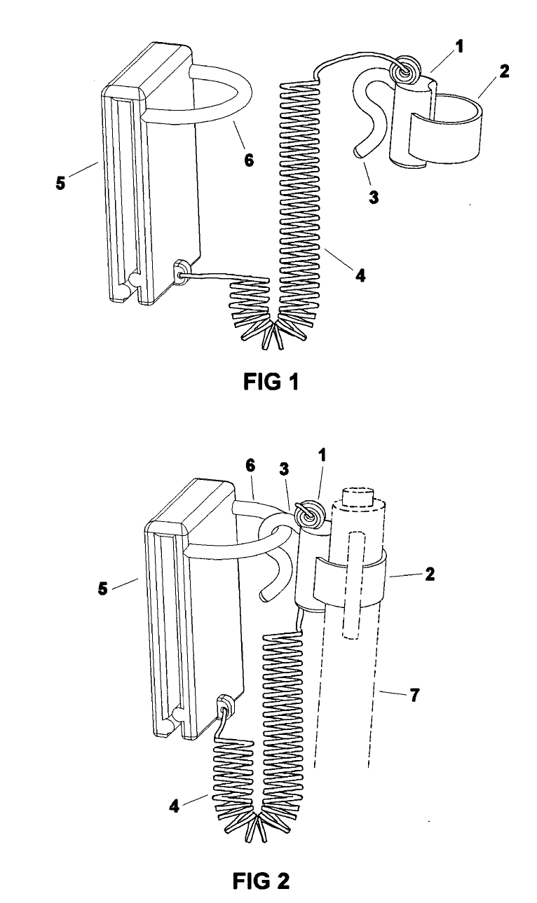

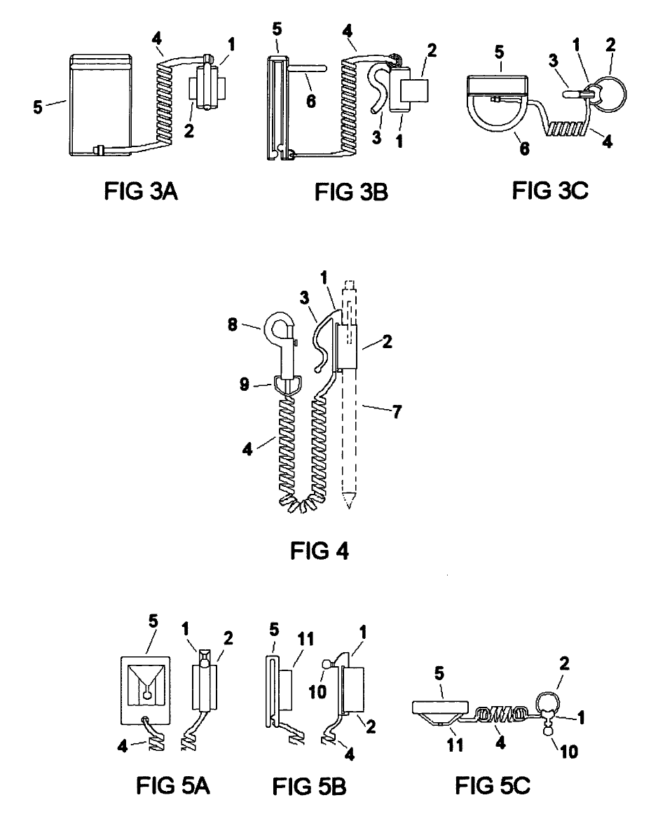

FIG. 1 shows a perspective view of one embodiment of the invention. Pen-connector 1 serves as a holder for a pen or other implement of the user's choice. An elastic band 2 snugly binds the chosen pen to the pen-connector over a wide variety of pen shapes and sizes, effectively forming a single pen and pen-connector unit. The pen-connector attaches high on the pen barrel so it does not interfere with gripping the pen normally for writing. Hook 3 is flexible and slides over ring 6 of the pen-holder 5 where it hangs coupled to the pen-holder when not in use. Retractile coil cord 4 binds the pen-connector to the pen-holder such that they cannot be separated more than the length of cord 4. Cord 4 has sufficient tension to retract automatically for storage but not so much tension as to impede writing with the pen-connector at a normal arm's distance. The pen-holder 5 forms a clip which easily attaches to a belt, waistband, or other article of clothing.

FIG. 2 shows a perspective view of the same embodiment as FIG. 1, but shows part of an example pen 7 (in dashed lines) already attached to the pen-connector 1 by band 2, and also shows pen-connector 1 in its position of storage with hook 3 coupled with ring 6 of pen-holder 5. The pen-connector 1 and pen 7 thereby remain stored at the waist until needed, at which time they are removed from the ring 6 of pen-holder 5 as a single unit and used normally for writing.

Another alternative for storage (not shown) is passing the pen 7 itself (if it is of suitable diameter)—rather than hook 3—through the ring 6, thereby using the pen-holder's ring 6 as a holster. In this position, the pen-connector 1 and its hook 3 coupled to the pen 7 serve to prevent the pen 7 from falling completely through the ring 6.

FIG. 4. shows an alternative embodiment of the invention wherein the pen-holder is formed of a clasp 8 which attaches to one's pant's belt-loop and a ring 9 component which couples with hook 3 of the pen-connector for storage (as it did similarly with ring 6 in FIG. 2.)

FIGS. 5A-C show an alternative embodiment of the invention wherein the coupling between the pen-connector 1 and pen-holder 5 is accomplished by a lock-and-key type configuration. Pen-connector 1 has a key component 10 which slides into a slot 11 of pen-holder 5 for pen storage. The key 10 and slot 11 geometries are such that the key 10 only slides in and out of the slot 11 when the pen-connector 1 (and attached pen) are oriented parallel to the ground. When the pen and pen-connector 1 naturally return by gravity to a near vertical orientation, the pen-connector cannot slide out of the pen-holder, thus preventing unintentional separation of the pen-connector from the pen-holder.

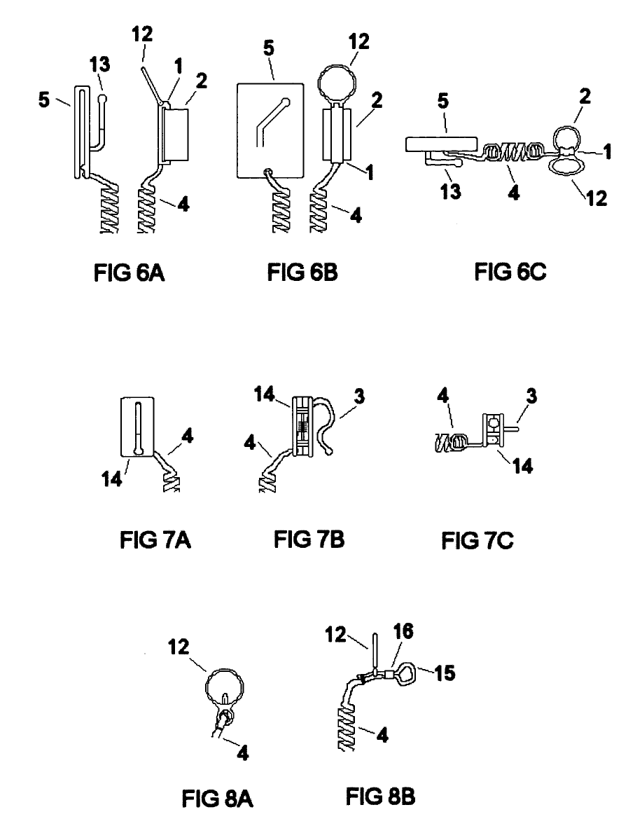

FIGS. 6A-6C show an alternative embodiment of the invention wherein the ring and hook coupling structures are reversed compared with the embodiment in FIG. 1. In the present embodiment, ring 12 on pen-connector 1 couples with hook 13 on pen-holder 5 during pen storage.

FIGS. 7A-C show an alternative embodiment of the pen-connector wherein the elastic band 2 of the pen-connector 1 embodied in FIG. 1 is replaced by a spring-based clamp 14. This clamp 14 opens to accommodate and hold pens of various diameters. However, the speed and ease with which the pen may be removed from this clamp makes it a less secure arrangement.

FIGS. 8A-B show an alternative embodiment of the pen-connector wherein the pen-connector 1 and elastic band 2 in FIG. 6 is replaced by a loop of cord with a sleeve 16 which allows flexibility in sizing the loop 15 to accommodate and hold pens of a variety of sizes. Loop 15 is placed around the upper barrel of the pen (under the pen-clip if present) and the loop is then tightened with the sleeve 16. Again, ring 12 couples with hook 13 (as in FIG. 6) for storage.

Other embodiments (not illustrated) of the system could utilize Velcro or magnets to couple the pen-connector and pen-holder. Also, permanent coupling of a pen and the pen-connector could be achieved by using an adhesive substance between the two as may be desirable if the retaining system is pre-packaged with a special promotional logo pen.

Although specific embodiments of the invention have been shown and described in detail in order to illustrate the application of the principles of the present invention, it is to be understood that the invention may be embodied in otherwise modified forms by those skilled in the art without departing from the spirit and scope of this invention as defined by the appended claims.

What is claimed is:

1. A system for retaining a pen (or similarly-shaped implement) which holds and prevents loss thereof comprising:
an adjustable pen-connector which couples a pen with the retaining system;
a wearable pen-holder to hold said pen-connector and coupled pen for storage;
a retractile cord coupling said pen-connector and pen-holder.

2. The pen retaining system according to claim 1, wherein the said pen-connector contains a flexible or adjustable fastener which can accommodate pens of various shapes and sizes and hold them in close and firm contact with the pen-connector.

3. The pen retaining system according to claim 1, wherein the said pen-connector contains a structure which reversibly couples with an appropriate structure on said pen-holder for storage.

4. The pen retaining system according to claim 1, wherein the said pen-holder contains a structure which reversibly couples with an appropriate structure on said pen-connector for storage.

5. The pen retaining system according to claim 1, wherein the said pen-holder contains a structure which easily and reversibly attaches to an article of clothing.

6. The pen retaining system according to claim 1, wherein the said retractile cord securely joins the said pen-connector and said pen-holder without excessive tension between the two.
